(19) United States
(12) Patent Application Publication
(10) Pub. No.: US 2005/0171993 A1
(43) Pub. Date: Aug. 4, 2005

(54) Element management system architecture without using SNMP

(76) Inventors: Vijay Singh Phagura, Santa Rosa, CA (US); Anita Phagura, Santa Rosa, CA (US)

Correspondence Address: Vijay S. Phagura, 3436 Baldwin Way, Santa Rosa, CA, 95403, US

(21) Appl. No.: 10/767,306

(22) Filed: Jan. 30, 2004

(51) Int. Cl. G06F 15/16

(52) U.S. Cl. 709/200

(57) ABSTRACT

The Element Management System (EMS) software which manages hardware and its component software have to always use Simple Network Management Protocol (SNMP) to manage the components, conventionally. This limits the capability of an EMS and presents additional problems to manage a component. This solution presented here eliminates the use of SNMP, by illustrating more efficient modes of control. The solution also segregates data into real-time data and static data.

### BACKGROUND

This invention is in the field of communications, and is more particularly directed to the architecture of any Element Management System (EMS), which manages real-time hardware or software.

Over the last decade the telecommunications network has been in transition. The old network was primarily designed for switched-voice traffic and was relatively simple. It was based on copper loops for subscriber access and a network of telephone exchanges to process calls. This network is evolving into one designed for integrated access, transport, and switching of voice, high-speed data, and video. Networks today, are composed of a wide variety of network elements (NEs) from a large number of vendors. As a result of its complexity, each network element technology is accompanied by an EMS that harnesses the power of the technology while masking its complexity.

An EMS manages one or more of a specific type of telecommunications network element (NE). Typically, the EMS manages the functions and capabilities within each NE but does not manage the traffic between different NEs in the network. To support management of the traffic between itself and other NEs, the EMS communicates upward to higher-level network management systems (NMS).

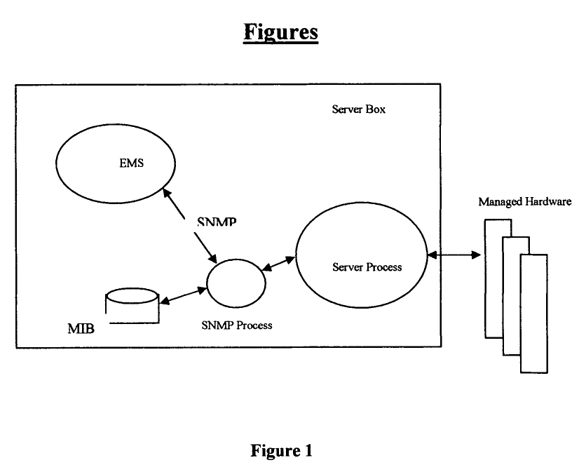

Traditionally, to efficiently manage a network, the NE reports its operational state to the EMS which stores this information in a database. Additionally, the EMS may transmit this operational data to a higher-level if necessary. These traditional systems are very complex and use many protocols to do their job. One of the protocols often used is SNMP to communicate to the NE. To work with SNMP the system needs the Management Information Base (MIB). A MIB is like a database with data as well as the schema. FIG. 1 shows a sketch of the a non-distributed system using SNMP. The following are the problems encountered by EMSs when using SNMP:
EMS stores its configuration & other information in a database. With SNMP, part of the data is also stored in the MIB, with this the task of data synchronization creeps in, as an added responsibility for the EMS. This involves a lot of work to make sure both data stores are in sync, in case of a failure.
Due to customer's expectations, the EMSs of today demand more and more info from the hardware, for which SNMP does not perform too well. It has too simple interfaces of ‘getters’ and ‘setter’ which also has other flavors of ‘bulk getters’ and ‘bulk setters’, which gets too tedious to use in terms of getting and setting a variety of data.
From a development perspective, including SNMP protocol in a system requires a SNMP infra-structure of agents and MIBs. This may require more software and debugging tools.
The EMS developers have to understand SNMP to know how the MIB is laid out to manage the hardware.
Since the EMSs of today have more demand on data and its consistency, it is important to use and manage transactions in it. Not only simple transactions but distributed transactions too. It is too hard, in terms of development effort and performance, to manage a SNMP call with transactions.
Error handling, from the EMS perspective, becomes very difficult and involves extra development.
‘Traps’ is the only asynchronous messaging mechanism from the server side, when using SNMP. This makes difficult for EMSs to differentiate between a trap from an unsolicited event. The solution presented by this invention eliminates all these, listed above, problems.

### SUMMARY

An object of the invention is to solve at least the above problems and/or disadvantages and to provide at least the advantages described hereinafter by removing SNMP.

Included below are two of the preferred embodiments of the present invention, examples of which are illustrated in the accompanying drawings.

Definations

1. In the document, the main application processes which are associated with the hardware directly are referred to as ‘server processes’.

The first embodiment eliminates SNMP by including a direct calling mechanism from the EMS to the server and from the server to the EMS. All calls appear as method calls from either side. This provides more control over transactions, error handling and messaging.

The second embodiment has the EMS send and receive Extensible Markup Language (XML) messages, synchronously and asynchronously. The XML messages can be proprietary or Simple Object Access Protocol (SOAP) specification messages. This solution requires added structure to support additional functionality and reliability.

EMS and the server-side processes can be written in different programming languages. For instance, Java, C# etc. In that case, there may be a bridging library.

### DETAILS

### Embodiment A

### Direct Call

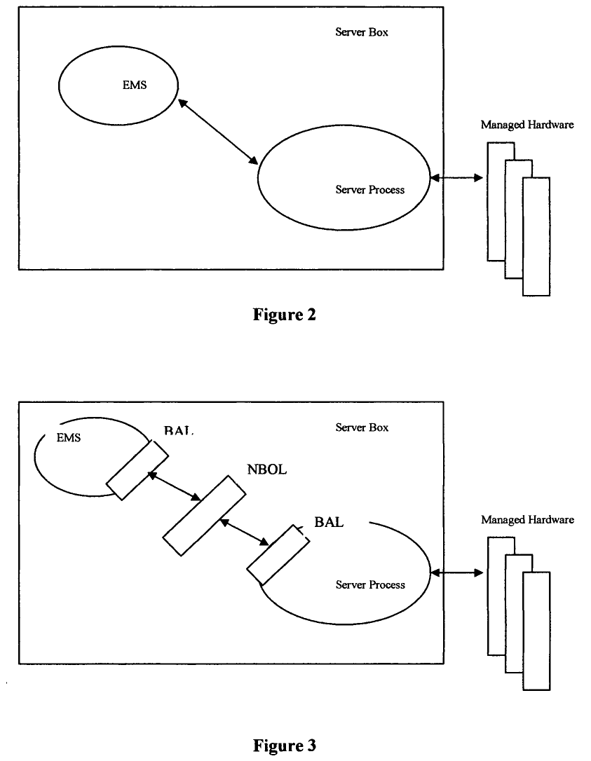

FIG. 2 shows how an EMS can call the server process on the same hardware server box. The EMS and the server are two separate processes.

For seamless interaction there are intermediate objects in the form of a library that either side can access. These objects are instances of classes written with a Native library, like Java Native Interface (JNI) in the case of Java. These objects can be called as Native Bridge Object Layer (NBOL).

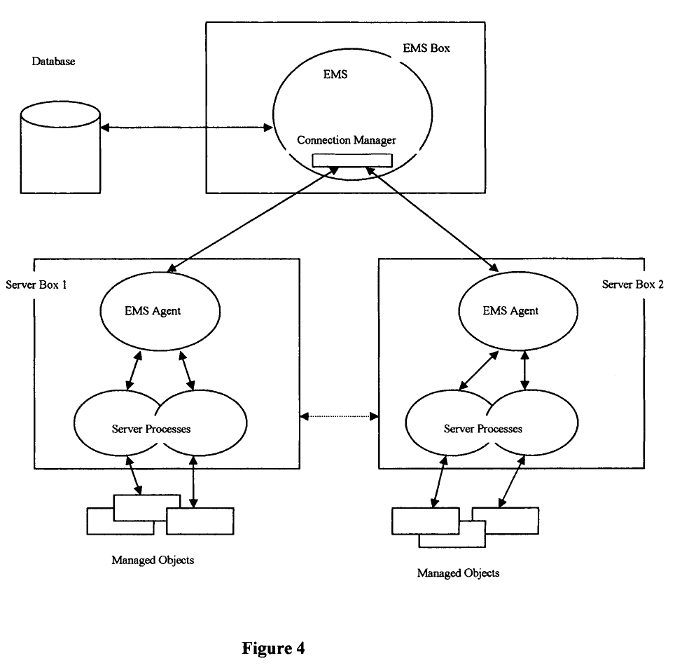

FIG. 3 shows more details of how the NBOL could be connected with the processes. There is another layer of objects called the Bridge Abstract Layer (BAL). This layer is further subdivided into two parts: one native to the EMS programming language and the other native to the server-side programming language. The objects or classes in these layers would be wrappers to the call to NBOL objects, where the BAL methods massage the parameters to call the NBOL operations. To make the development process easy both the BAL layers can publish an Interface Definition File (IDF), which may be a XML file, to let their interfaces known to the NBOL.

There are at least two reasons to have this abstraction layer:
1. It hides the NBOL from the feature developers on either side, which may have different syntax and semantics.
2. The person or team responsible for the NBOL development can read the method descriptions from the IDF file, to implement the Native bridge objects in the NBOL.

The BAL can also be packaged in a shared library for all the processes to share.

With these arrangements in mind, any process, shown in FIG. 2, can get information from one another at any time. Everything done is in the form of a method call, which ultimately can be treated as a message.

In a scenario, when the hardware failure occurs an alarm is generated and is sent to the controlling process. Which in turn calls a method, say sendTrap (Trap), on the relevant object, say TrapDispatcher, in the BAL library. Which in turn calls the operation in NBOL, this operation will call the corresponding object on the EMS side BAL. This EMS BAL will in turn call the trap handler object on the EMS side. The data can be sent across to the other side in an object. The NBOL may have to parse and massage some these objects to translate, but that is all implementation details.

FIG. 4 shows how this embodiment can be implemented in a distributed system. In a distributed system the server-side of the main application is on a different server box then the EMS server box. For this solution to work, the EMS has an agent on the server-side box which would be a separate process from the server process and would be still written in the programming language in which EMS is written in. This EMS-agent can be connected to the EMS with a TCP/IP connection. For instance, this communication can be taken care by a third party package as Java Dynamic Management Kit (JDMK), from Sun Microsystems®. The entire above discussion still holds good between the agent and the server process. All the communications goes through the agent on either side.

### Embodiment B

### XML Messaging

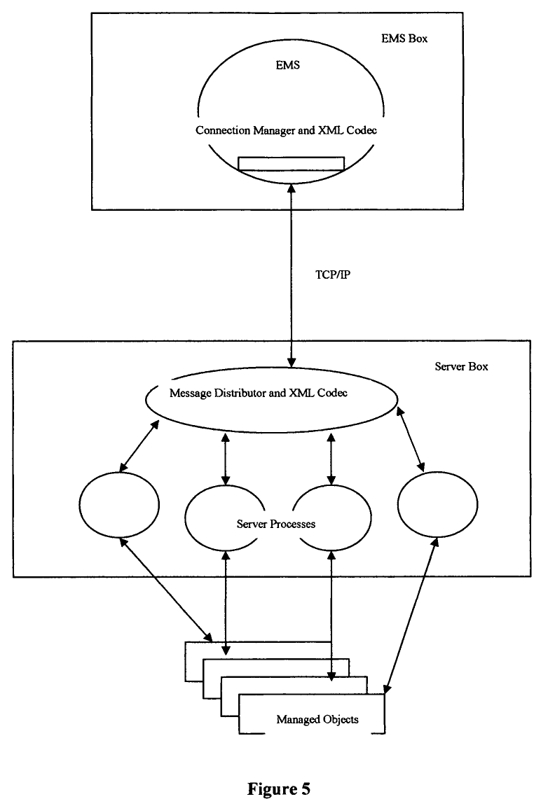

FIG. 5 shows how XML messages can be used to facilitate direct communication and eliminate SNMP. XML messages come in two flavors; one can be proprietary to the application, the other can use SOAP specification. Either way the basic essence is to use text messaging, neutral to programming languages.

For direct communication through XML messages there is an encoder and a decoder on either side and an infrastructure to support synchronous and asynchronous messaging. The infrastructure would support queuing and recognizing messages, which is out of the scope of this invention. In addition, the server-side may include a message dispatcher to distribute the translated incoming messages to various server processes.

After the process receives the message it performs the desired operation and sends the response. The EMS can get or set any data on the server-side using the XML messaging. Depending on how the messages are designed, any type of data can be sent and verified. As shown in FIG. 5, messaging is more useful in a distributed type of application. Also, XML messaging is easy to use as compared to any other form of text messaging as there are more tools available and specifications are laid out.

The other thing to note is that both the processes (EMS & server) can access the same database as they would do in a traditional EMS system. But, the database would only contain static info in this model. All the real-time information is retrieved by method calls directly from the server. The sever processes may store the real-time information in their own data store, which may be a memory, which is implementation detail. The database can also be used to communicate certain types of data like, large amount of data or critical data which should survive process failures. This can be done by the writer process writing the data to the database and then sending a notification message to the recipient, in a transaction.

1. An Element Management System (EMS), comprising: a system for managing elements of a communication network without using SNMP.

2. An EMS, comprising: a system for managing elements of a communication network wherein the system has a means for directly calling the network elements.

3. The EMS of claim 2, wherein: the EMS and the server processes are separate processes.

4. The EMS of claim 2, wherein: there is an intermediate native library that the EMS and the server processes can access.

5. The EMS of claim 4, wherein: there is an abstraction layer comprising two parts: one native to the EMS programming language and the other native to the language of the server processes.

6. The EMS of claim 5, wherein the abstraction layer publishes an Interface Definition File (IDF).

7. The EMS of claim 2, wherein: the EMS process and the server processes are distributed on different computers and the EMS has an agent on the server processes computer written in the same programming language as the EMS.

8. The EMS of claim 2, wherein: said EMS-agent is connected to the EMS with a TCP/IP connection.

9. The EMS of claim 7, wherein: there is an intermediate native library that the EMS agent and the server processes can access.

10. The EMS of claim 9, wherein: there is an abstraction layer comprising two parts: one native to the EMS programming language and the other native to the language of the server processes.

11. The EMS of claim 10, wherein the abstraction layer publishes an Interface Definition File (IDF).

12. An EMS, comprising: a system for managing elements of a communication network wherein the system uses XML messages to communicate to the network elements.

13. The EMS of claim 12, wherein: there the EMS and the server processes have an encoder and a decoder and a means to support synchronous and asynchronous messaging.

14. The EMS of claim 13, wherein: the server on which the server processes includes a message dispatcher to distribute the translated incoming messages to various server processes.

15. The EMS of claim 1 wherein the system has only one master database for non real-time data.

16. The EMS of claim 2 wherein the system has only one master database for non real-time data.

17. The EMS of claim 12 wherein the system has only one master database for non real-time data.
